(19) United States
(12) Patent Application Publication
(10) Pub. No.: US 2012/0085152 A1
(43) Pub. Date: Apr. 12, 2012

(54) Fluid analysis tool

(76) Inventor: Donald A. Funk, Saskatoon (CA)

(21) Appl. No.: 12/923,774

(22) Filed: Oct. 7, 2010

(51) Int. Cl. G01N 1/10

(52) U.S. Cl. 73/64.56

(57) ABSTRACT

Disclosed is an apparatus and method for analyzing a fluid. The apparatus comprises an elongate body having a piston therein defining first and second chambers within the elongate body, an opening through the elongate body in fluidic communication with the second chamber and an actuator operably connected to the piston so as to draw the piston away from the opening. At least a portion of the elongate body is transparent so as to permit a visual comparison of the second fluid and a first fluid contained within the first chamber. The method comprises introducing a volume of a control fluid into the first chamber, slidably and sealably moving the piston in a direction away from the opening so as to draw a volume of a sample fluid into the second chamber and visually comparing the control and the sample fluids to each other.

### BACKGROUND OF THE INVENTION

1. Field of Invention

The present invention relates to fluid analysis in general and in particular to a method and apparatus for visually comparing two fluid samples.

2. Description of Related Art

In many applications, is desirable to analyze a fluid utilized during that process or by a particular machine. For example, in the field of automotive maintenance, it is necessary to check the condition of one or more of the fluids of the vehicle, including the oil, coolant, transmission fluid and brake fluid. Proper monitoring and replacement of these fluids is an essential part of ensuring that the vehicle will last for the desired length of service.

Common conventional methods of testing fluid have been to utilize an electronic testing apparatus, with chemical reaction liquids or test strips, or a density measure among others. Such methods however are expensive and time consuming to perform. Typically consumers may not want to pay for the time and expense of having such a test performed. Additionally, many consumers may be less inclined to believe a test result that is given to them by a technician as they do not have the opportunity to perform the test themselves and see the test results. For such situations, it is often advantageous to be able to show the consumer the current appearance of the fluid.

Current methods of displaying fluids has been to pour the fluid in question into a container for viewing from the top and comparison with a reference chart. Such methods may not be satisfactory for all fluids, such as where one of the characteristics of the fluid to be assessed the opacity or degree of clarity. Additionally, the appearance, in particular color, may be affected by the color of the container into which the fluid is poured. The appearance of such characteristics may be adversely affected by the size, color, material or shape of the container into which the fluid is poured thereby adversely impairing the ability to compare the fluid to a reference picture which does not include these additional modifications due to the container.

Additionally, it may also be advantageous to compare the fluid being tested against a clean, or baseline fluid so as to show the change in appearance of the fluid from when it was new. Current methods of doing this have been to provide two containers which may hold the base and the sampled fluid wherein the two containers may then be visually compared to each other. Such methods may be messy due to pouring multiple fluids into containers. Such methods may also occupy an unnecessary amount of time.

### SUMMARY OF THE INVENTION

According to a first embodiment of the present invention there is disclosed an apparatus for analyzing a fluid comprising an elongate body having a central cavity therein and a piston sealably and slidably axially moveable within the central cavity, the piston defining and sealably separating first and second chambers within the elongate body. The apparatus further comprising an opening through the elongate body in fluidic communication with the second chamber and an actuator operably connected to the piston so as to draw the piston away from the opening so as to draw a second fluid into the second chamber. At least a portion of the elongate body is transparent so as to permit a visual comparison of the second fluid and a first fluid contained within the first chamber.

The elongate body may be formed of a cylindrical member and opposed first and second end caps. The cylindrical body may extend along a tool axis. The cylindrical body may be transparent The cylindrical body may be formed of polyethylene terephthalate.

The first and second end caps may be formed of a metal. The first and second end caps may be threadably secured to the cylindrical member. The first end cap may be selectably -removable so as open the first chamber permitting the first fluid to be introduced thereto. The second end cap may include the opening therethrough.

The apparatus may further comprise a tube extending from the opening in fluidic communication therewith. The tube may be selectably connectable to the opening. The tube may be connectable to the opening by a tube connector.

The actuator may comprise a rod extending from the piston. The rod may extend axially along an axis of the tool. The rod may extend through an end cap of the elongate body. The rod may include a handle at a distal end thereof.

According to a further embodiment of the present invention there is disclosed a method for analyzing a fluid comprising introducing a volume of a control fluid into a first chamber of an elongate body, slidably and sealably moving a piston along the elongate body in a direction towards the first chamber so as to draw a volume of a sample fluid into a second chamber of the elongate body through an opening therein and visually comparing the control and the sample fluids to each other.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of a fluid comparison apparatus according to a first embodiment of the present invention.

FIG. 2 is an exploded view of the fluid comparison apparatus of FIG. 1.

FIG. 3 is a cross-sectional view of the fluid comparison apparatus of FIG. 1 as taken along the line 3-3 with the piston at a first position.

FIG. 4 is a cross-sectional view of the fluid comparison apparatus of FIG. 1 as taken along the line 3-3 with the piston at a second position.

### DETAILED DESCRIPTION

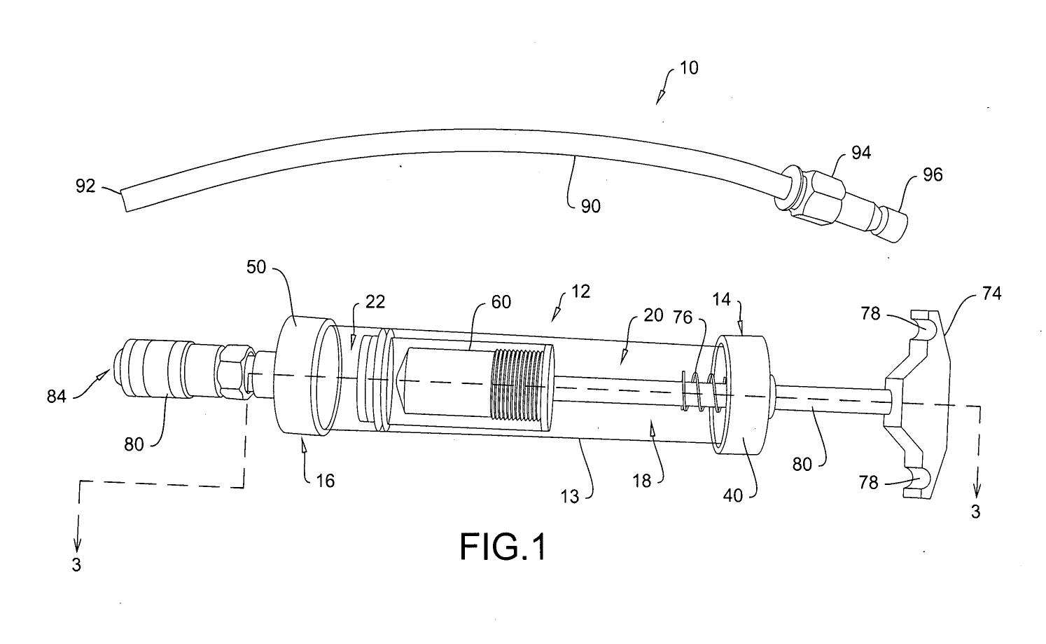

Referring to FIG. 1, an apparatus for analysing a fluid according to a first embodiment of the invention is shown generally at 10. The apparatus 10 comprises an elongate cylindrical body 12, extending between first and second ends 14 and 16, respectively and having a cavity 18 therein and a piston 60 slidably and sealably received within the cavity. The piston 60 separates the cavity 18 into and defines first and second chambers 20 and 22, respectively, within the cavity 18. The apparatus 10 further includes first and second end caps, 40 and 50, respectively, enclosing the first and second chambers 20 and 22 and a pick-up tube 90 extending from the second end cap 50

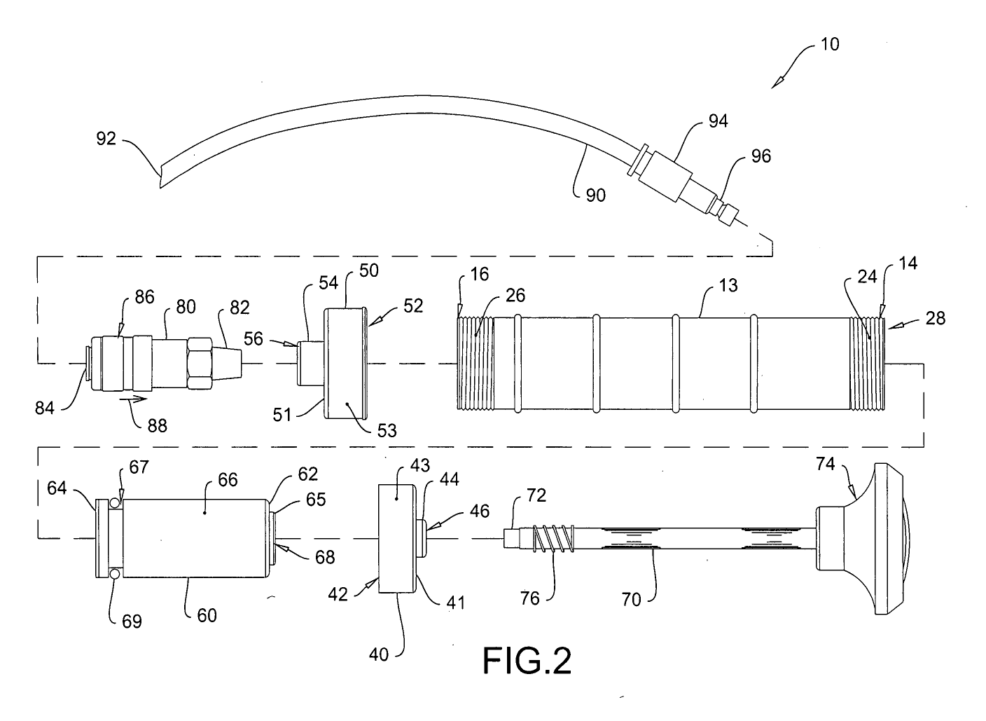

With reference to FIG. 2, the cylindrical body 12 comprises a tube 13 having first and second ends 14 and 16. Each of the first and second ends 14 and 16 may include exterior threading, 24 and 26, respectively, for securing the first and second end caps 40 and 50 thereto as will be further explained below. The tube 13 includes a central bore 28 extending therethrough along a central axis 30 sized to receive the piston 60 therein. As illustrated and described above, the tube 13 may be cylindrical, although it will be appreciated that other cross-sectional shapes may be useful as well, such as, by way of non-limiting example, triangular, square, octagonal, oval, or irregular provided the piston 60 is sized and shaped to be sealably received therein so as to prevent mixing of the fluids contained in each of the first and second chambers. The tube 13 may be formed of any suitable material selected to be substantially transparent. Optionally the tube 13 may be formed to have a transparent portion so as to permit observation of the contents of the apparatus. In particular, the tube may be formed of any suitable transparent material which is impact resistant and chemically neutral with common automotive fluids, such as by way of non-limiting example co-polymerized polyethylene terephthalate (PETG).

The first end cap 40 includes a disk portion 41 and a sleeve portion 43 at a distal edge thereof. The first end cap 40 encloses the first end 14 of the tube 13 within an interior thereof. Optionally, the first end cap 40 may include interior threading 42 adapted to engage with the exterior threading 24 on the first end 14 of the tube 13 although other means for securing the end caps to the tube may be utilized as well. In this way, the first end cap 40 may be threadably secured onto the first end 14 of the tube 13. The first end cap 40 also includes an extension 44 extending axially from the disk portion 41. The extension 44 includes a bore 46 therethrough sized to pass a rod as will be further described below.

The second end cap 50 includes a disk portion 51 and a sleeve portion 53 at a distal edge thereof. The second end cap 50 encloses the second end 16 of the tube 13 within an interior thereof. Optionally, the second end cap 50 may include interior threading 52 adapted to engage with the exterior threading 26 on the second end 16 of the tube 13 although other means for securing the end caps to the tube may be utilized as well. In this way, the second end cap 50 may be threadably secured onto the second end 16 of the tube 13. The first end cap 50 also includes an extension 54 extending axially from the disk portion 51. The extension 54 includes a threaded bore 56 therethrough to receive a drawing tube connection as will be more fully described below. The threaded bore 56 also maintains the second chamber 22 which is adjacent to the second end cap 50 in fluidic communication with the drawing tube connection. The first and second end caps may be formed of any suitable material such as steel, brass, copper, stainless steel, plastics, ceramics or any other suitable material.

The piston 60 comprises an elongate tubular member extending between first and second ends, 62 and 64, respectively and has an exterior surface 66.

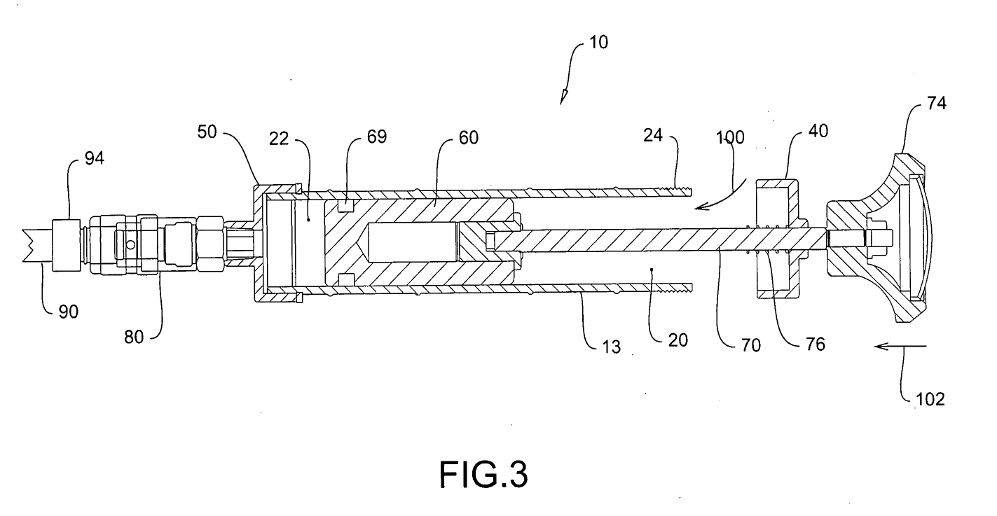

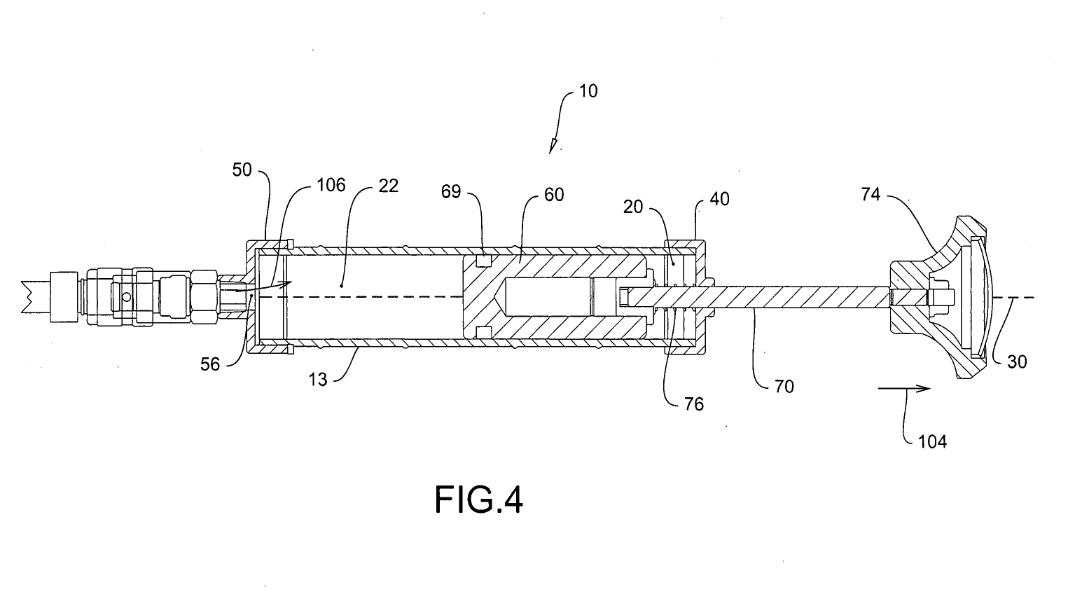

The exterior surface 66 is sized and shaped to closely correspond to the central bore 28 of the tube 13. The exterior surface 66 also includes a groove 67 therearound adapted to receive an o-ring 69 or other suitable seal therein. The o-ring 69 seals the space between the piston 60 and the tube 13 so as to sealably separate the first and second chambers 20 and 22. As illustrated in FIG. 1, the first chamber 20 is formed between the first end 62 of the piston 60 and the first end cap 40. The second chamber 22 is formed between second end 64 of the piston and the second end cap 50. The first end 62 of the piston 60 also includes a piston bore 68 therein. The piston bore 68 threadably receives an actuator rod 70 therein. The piston bore 68 may optionally be carried within a piston plug 65 engaged within a cavity in the piston 60 as illustrated in FIGS. 3 and 4. The piston 60 may be similarly formed of transparent materials as the tube 13.

The apparatus 10 further includes an actuator which, as illustrated in the accompanying figures may comprise a rod 70. The rod 70 has a diameter selected to be received within the bore 46 of the first end cap 40 and form a seal therebetween so as to seal the first chamber 20. The rod 70 includes a first threaded end 72 and a handle 74 at a second end. The rod 70 also includes a compression rod spring 76 located therearound, the purpose of which will be described below. The handle 74 may comprise a circular knob-type handle as illustrated in FIGS. 2 through 4. Optionally, the handle may comprise a finger grip style handle as illustrated in FIG. 1 having finger grip locations 78 or any other suitable handle type as will be appreciated.

The second end cap 50 includes a quick coupler 80 connected thereto. The quick coupler 80 includes a threaded end 82 and an open end 84. The open end 84 includes a quick release ring 86 forming a quick-connection socket which may be pulled backwards in a direction generally indicated at 88 to release or attach a corresponding coupler connected to the pick-up tube 90 as will be explained below. The quick coupler 80 includes a bore therethrough (not shown) so as to maintain the second chamber 22 in fluidic communication with the pick-up tube 90 when attached. The quick coupler 80 may optionally be valved so as to close and seal the second chamber 22 from the outside environment when a pick-up tube 90 is not connected thereto as are commonly known.

The pick-up tube 90 comprises an elongate tube having an open end 92 and a connection end 94. The connection end 94 includes a quick connection plug 96 operable to cooperate with the quick connection socket of the quick coupler 80 to be interconnected therewith. The pick-up tube 90 may have a length selected according to the desired application. By way of non-limiting example, the pick-up tube 90 may have a length between of 6 and 30 inches (152 and 762 mm) although it will be appreciated that different lengths may be useful for use with different fluids and automotive types. It will be appreciated that other ranges may be useful as well depending upon the application and the distance between a fluid source and the availability of user access thereto; It will also be appreciated that the use of a quick-connect style coupler as described above will facilitate the use of pick-up tubes 90 of differing lengths. The pick-up tube 90 may be formed of any suitable material such as natural or synthetic rubber, silicone, plastics such as polyethylene or polystyrene, and may optionally be flexible so as to facilitate introduction of the pick-up tube 90 into a variety of fluid sources.

The apparatus 10 is assembled by passing the tube 90 through the bore in the first end cap and threadably securing the threaded end 72 into the piston bore 68 such that the rod spring 76 is between the piston and the first end cap. The piston 60 may then be located within the central bore 28 of the tube 13. The second end cap 50 may be threadably secured onto the second end 16 of the tube 13 and the threaded end 82 of the quick coupler 80 threadably secured into the threaded bore 56 of the second end cap 50.

With reference to FIGS. 3 and 4, in operation, a sample of a reference fluid may be introduced by pouring or otherwise into the open first end 14 of the tube 13 in a direction generally indicated at 100. The first end cap 40 may then be threadably secured to the first end of the tube such that the reference fluid is retained within the first chamber 20 between the piston 60 and the first end cap 40. The piston may then be located to a position adjacent to the second end cap 50 by pushing the handle 74 towards the second end cap 50 in a direction generally indicated at 102. Optionally, the piston 60 may be located adjacent to the second end cap 50 before the reference fluid is introduced to the first chamber 20.

To test a sample, the quick connection plug 96 may be secured within the quick coupler 80 so as to attach a pick-up tube 90 to the cylindrical body 12 and second end cap 50. The open end 92 of the pick-up tube 90 may then be inserted into a fluid reservoir (not shown) of the fluid to be tested and the handle 74 drawn away from the second end cap 50 in a direction generally indicated at 104 so as to draw the sample fluid into the second chamber 22 through the pick-up tube 90. Thereafter the apparatus may be held up for visual inspection by a user so as to compare the appearance of the reference fluid in the first chamber 20 and the sample fluid in the second chamber 22. By way of non-limiting example the color of each fluid may be compared to each other, the clarity of each fluid may be compared to each other or the thickness or viscosity of each fluid may be compared to each other by moving the apparatus to observe the relative movement of each fluid therein. During and after the process of drawing the sample fluid into the second chamber 22, the rod spring 76 serves as a cushion between the piston 60 and the first end cap 40.

While specific embodiments of the invention have been described and illustrated, such embodiments should be considered illustrative of the invention only and not as limiting the invention as construed in accordance with the accompanying claims.

What is claimed is:

1. An apparatus for analyzing a fluid comprising:
an elongate body having a central cavity therein;
a piston sealably and slidably axially moveable within said central cavity, said piston defining and sealably separating first and second chambers within said elongate body;
an opening through said elongate body in fluidic communication with said second chamber;
an actuator operably connected to said piston so as to draw said piston away from said opening so as to draw a second fluid into said second chamber,
wherein at least a portion of said elongate body is transparent so as to permit a visual comparison of said second fluid and a first fluid contained within said first chamber.

2. The apparatus of claim 1 wherein said elongate body is formed of a cylindrical member and opposed first and second end caps.

3. The apparatus of claim 2 wherein said cylindrical member extends along an axis of the tool.

4. The apparatus of claim 2 wherein said cylindrical member is transparent.

5. The apparatus of claim 4 wherein said cylindrical member is formed of polyethylene terephthalate.

6. The apparatus of claim 2 wherein said first and second end caps are formed of a metal.

7. The apparatus of claim 6 wherein said first and second end caps threadably secured to said cylindrical member.

8. The apparatus of claim 2 wherein said first end cap is selectably removable so as open said first chamber permitting said first fluid to be introduced thereto.

9. The apparatus of claim 2 wherein said second end cap includes said opening therethrough.

10. The apparatus of claim 1 further comprising a tube extending from said opening in fluidic communication therewith.

11. The apparatus of claim 10 wherein said tube is selectably connectable to said opening.

12. The apparatus of claim 11 wherein said tube is connectable to said opening by a tube connector.

13. The apparatus of claim 1 wherein said actuator comprise a rod extending from said piston. I

14. The apparatus of claim 13 wherein said rod extends axially along said tool axis.

15. The apparatus of claim 13 wherein said rod extends through an end cap of said elongate body.

16. The apparatus of claim 13 wherein said rod includes a handle at a distal end thereof.

17. A method for analyzing a fluid comprising:
introducing a volume of a control fluid into a first chamber of an elongate body;
slidably and sealably moving a piston axially within a chamber in said elongate body in a direction towards said first chamber so as to draw a volume of a sample fluid into a second chamber of said elongate body through an opening therein; and
visually comparing said control and said sample fluids to each other.
